(19) United States
(12) Patent Application Publication
(10) Pub. No.: US 2022/0033627 A1
(43) Pub. Date: Feb. 3, 2022

(54) SILANE MODIFIED STYRENE BUTADIENE COPOLYMER FOR HIGH PERFORMANCE IN DRY ADHERENCE, WET ADHERENCE AND ROLLING RESISTANCE

(71) Applicant: FINA TECHNOLOGY, INC., Houston, TX (US)

(72) Inventors: Fabien Salort, Balagny-sur-therain (FR); Daniel Krulis, Praha 6 (CZ); Steven K. Henning, Downingtown, PA (US); Jean-Marc Monsallier, Metz (FR)

(73) Assignee: FINA TECHNOLOGY, INC., Houston, TX (US)

(21) Appl. No.: 16/942,258

(22) Filed: Jul. 29, 2020

(51) Int. Cl. C08L 19/00; C08G 77/20; C08L 83/04; C08K 3/36; C08K 3/04; B60C 1/00

(52) U.S. Cl. CPC C08L 19/006; C08G 77/20; B60C 1/0016; C08K 3/36; C08K 3/04; C08L 83/04

(57) ABSTRACT

A curable rubber composition is provided which includes a high molecular weight diene elastomer; an optional carbon black composition; a silica composition; and a silane terminated copolymer different from the high molecular weight diene elastomer including conjugated dienes and vinyl aromatics as polymerized monomers. The silane terminated copolymer has at least one terminal end modified with at least one silane group and the silane terminated copolymer has a number average molecular weight of from 1,000 g/mol to 40,000 g/mol. A method for producing a rubber composition for use in a tire is provided. The method includes forming a composition by mixing the silane terminated copolymer modified with at least one silane group, a silica composition, a high molecular weight diene elastomer different from the silane terminated copolymer, and optionally a carbon black composition; and curing the composition.

### FIELD OF THE INVENTION

The present invention is directed to rubber compositions including silane terminated copolymers including conjugated dienes and vinyl aromatics as polymerized monomers and, more particularly, to rubber compositions for forming tires including the same.

### BACKGROUND OF THE INVENTION

Modern silica-filled tires require materials having a balance of a host of opposing and stringent physical properties. For example, the physical properties necessary to maintain good wet and dry adhesion to the road for safety, and those needed for low rolling resistance for improved fuel economy will often suffer at the expense of reducing one while improving the other. In particular, a high loss modulus (viscous component) is associated with good wet and dry adherence to roadways and good braking, but a high storage modulus (elastic component) is associated with lower (good) rolling resistance. These two properties typically oppose each other, i.e. if one is high, the other is low. At the same time, it is important also to maintain tire durability for safety and economic reasons as well, and good dispersion and compatibility with the silica fillers in modern tires are necessary for some of the durability performance. Furthermore, for tires intended to be used in the summer, higher (albeit still low) glass transition temperatures (Tg) may be desirable.

Manipulating rubber compositions, specific to improving advantageous physical properties for tires made from such compositions is of particular interest for tire manufacturers. Reducing fuel consumption may be obtained by developing tires having a very low rolling resistance combined with excellent grip properties and handling behavior. This can produce significant cost and environmental benefits because improved physical properties of the tires can reduce fuel consumption. Accordingly, there is a constant need for improved materials that will reduce manufacturing costs and produce rubber compositions having advantageous physical properties, including excellent wet and dry traction combined with low rolling resistance, and high durability, and further having the Tg of the cured composition shifted higher, which is especially important in summer driving conditions.

### SUMMARY OF THE INVENTION

The inventors have found that certain curable rubber compositions including particular silane terminated copolymers that include conjugated dienes and vinyl aromatics as polymerized monomers impart the desired combination of properties to the cured rubber compositions: excellent wet and dry traction combined with low rolling resistance, high durability, and further having the Tg shifted higher.

Aspects of the invention are directed to rubber compositions including silane functionalized terminal silane modified polymers.

According to one aspect of the invention, a curable rubber composition is provided. The curable rubber composition comprises, consists of or consists essentially of: a high molecular weight diene elastomer; a silica composition; an optional carbon black composition; and a silane terminated copolymer different from the high molecular weight diene elastomer and including, as polymerized units, monomers including conjugated dienes and vinyl aromatics. The silane terminated copolymer having at least one terminal end modified with at least one silane group, wherein the silane terminated copolymer has a number average molecular weight of from 1,000 g/mol to 40,000 g/mol.

According to another aspect of the invention, a tire is provided. The tire comprises, consists of, or consists essentially of a rubber composition obtained by curing a curable rubber composition. The curable rubber composition comprises, consists of, or consists essentially of a high molecular weight diene elastomer; a silica composition; an optional carbon black composition; and a silane terminated copolymer different from the high molecular weight diene elastomer and comprising, consisting of or consisting essentially of, as polymerized units, monomers comprising, consisting of or consisting essentially of conjugated dienes and vinyl aromatics. The silane terminated copolymer has at least one terminal end modified with at least one silane group, and has a number average molecular weight of from 1,000 g/mol to 40,000 g/mol.

According to yet a further aspect of the invention, provided is a method for producing a rubber composition for use in a tire. The method comprises, consists of or consists essentially of: forming a composition by mixing a silica composition, a high molecular weight diene elastomer, an optional carbon black composition, and a silane terminated copolymer different from the high molecular weight diene elastomer. The silane terminated copolymer comprises, consists of or consists essentially of, as polymerized units, monomers comprising, consisting of or consisting essentially of conjugated dienes and vinyl aromatics, the silane terminated copolymer having at least one terminal end modified with at least one silane group. The silane terminated copolymer has a number average molecular weight of from 1,000 g/mol to 40,000 g/mol; and curing the composition.

According to a further aspect of the invention, provided is a tire having a rubber composition obtained by curing a curable rubber composition. The curable rubber composition comprises, consists essentially of, or consists of a high molecular weight diene elastomer; a silica composition; optionally, a carbon black composition; and a terminal silane modified polymer comprising, consisting of or consisting essentially of at least one terminal end modified with at least one silane group. The terminal silane modified polymer is modified with (i.e., contains, for example in a terminal position) at least one silane group, and has a number average molecular weight of 1,000 g/mol to 40,000 g/mol.

According to yet a further aspect of the invention, provided is a method for producing a rubber composition for use in a tire. The method comprises, consists essentially of or consists of forming a composition by mixing a high molecular weight diene elastomer, a terminal silane modified polymer modified with at least one silane group in a terminal position, a silica composition, and optionally a carbon black composition; and curing the composition.

### BRIEF DESCRIPTION OF THE DRAWINGS

The invention is best understood from the following detailed description when read in connection with the accompanying drawings. Included in the drawings are the following figures:

FIG. 1 is a plot showing the peak tan δ temperatures of certain cured rubber compositions;

FIG. 2 is a plot showing relative peak tan δ temperature shift of cured rubber compositions as a function of the Tg of certain polymers included in the cured rubber compositions;

FIG. 3 is a plot of the Payne Effect for certain cured rubber compositions; and

FIG. 4 is a graph showing the relative tire performance of certain cured rubber compositions.

### DETAILED DESCRIPTION OF THE INVENTION

Improved rubber compositions may be produced using aspects of the present invention. Applicants have discovered that a balance of properties of good wet and dry adhesion and low rolling resistance together with high temperature performance may be achieved by the addition of a terminally silane functional low molecular weight polymer, such as copolymers of conjugated dienes and vinyl aromatic monomers, in a rubber compound containing silica as a fillers. For example, in accordance with one aspect of the invention, improved silica dispersion and low temperature performance good wet and dry adhesion and low rolling resistance together with high temperature performance may be achieved utilizing the silane functional low molecular weight polymer disclosed herein, which may, in some embodiments, be adapted particularly for applications relating to tire production. The improvement in properties through the use of the low molecular weight silane functional polymer results in improved viscoelastic properties, which may be correlated to increased fuel economy and improved summer performance in tire tread compounds.

Thus, reduced fuel consumption may be obtained by developing tires having a very low rolling resistance combined with excellent grip properties and handling behavior, thereby promoting significant cost and environmental benefits. As discussed in more detail below, in one embodiment, greatly improved wet and dry adhesion (grip) and low rolling resistance, together with a higher (albeit still relatively low) Tg may be obtained using terminally functionalized silane polymers of conjugated dienes and vinyl aromatics, and optionally, other monomers. In one embodiment, the silane group is represented by the following formula: —Si(OR)₃, where each R is independently a C1-C6 alkyl group (e.g., methyl, ethyl) or an aryl group (e.g., phenyl).

According to another aspect of the invention, a curable, silica containing-rubber compound is provided with improved wet and dry adhesion, lower rolling resistance and higher Tg, which contains at least a terminal silane modified polymer comprising as monomers, conjugated diene and vinyl aromatic monomers, and optionally other co-monomers, in polymerized form. The rubber composition may comprise 1 to 150 parts terminal silane modified polymer, 5 to 120 parts of a silica, 0 to 100 parts of a carbon black, and 0 to 100 phr of one or more high molecular weight diene elastomers, that are different from the terminal silane modified polymer. The rubber composition may include 1 to 140 parts of terminal silane modified polymer, e.g., 2 to 110 parts of terminal silane modified polymer, 3 to 100 parts of terminal silane modified polymer, 5 to 90 parts of terminal silane modified polymer, 7 to 80 parts of terminal silane modified polymer, 9 to 70 parts of terminal silane modified polymer, 11 to 60 parts of terminal silane modified polymer, 13 to 50 parts of terminal silane modified polymer, 15 to 45 parts of terminal silane modified polymer, 17 to 40 parts of terminal silane modified polymer, or 19 to 30 parts of terminal silane modified polymer. In other, non-limiting embodiments, the amount of terminal silane modified polymer in the rubber composition is 1 to 50 parts terminal silane modified polymer, 50 to 100 parts terminal silane modified polymer, or 100 to 150 parts terminal silane modified polymer. The amount of silica in the rubber composition may be, e.g., 6 to 90 parts of silica, 7 to 60 parts of silica, 8 to 40 parts of silica. The high molecular weight diene elastomers used in the rubber composition may include, but are not limited to, styrene butadiene rubber, butadiene rubber, polyisoprene rubber, or natural rubber, or blends of these rubber elastomers. The amount of high molecular weight diene elastomers in the rubber composition may be 0 to 100 phr, 5 to 90 phr, 10 to 80 phr, 15 to 70 phr, or 20 to 60 phr of high molecular weight diene elastomers. The high molecular weight diene elastomer may have a number average molecular weight Mₙ of 100,000 Da or more, 200,000 Da or more, 300,000 Da or more, etc.

The terminal silane modified polymer may be a relatively low number average molecular weight polymer, for example having a number average molecular weight of 1,000 to 40,000 Da, or from 1000 to 25,000 Da or having a number average molecular weight from 2000 to 10,000 Da or from 2,500 to 10,000 Da.

The present inventors have discovered that embodiments of the present invention provide advantages over rubber compositions utilizing non-functionalized liquid poly(butadiene)s. Non-functionalized liquid poly(butadiene)s have been used in tire compounding. Due to their wide range of glass transition temperatures (Tg), low molecular weight diene elastomers are used as plasticizers to increase the grip properties or the low temperature performance behavior of tires. These low-molecular weight non-functionalized polymers have the disadvantage of producing tires with poor rolling resistance performance.

However, according to one aspect of the invention, the rubber composition includes a terminal silane modified polymer bearing one or more silane groups (for example, in one or more terminal positions), which enables rubber compositions having sufficient wet and dry grip properties, low rolling resistance and high temperature performance without low molecular weight dienes. In accordance with an aspect of the present invention, a method is provided for producing a terminal silane modified polymer comprising terminal silane groups. The method includes functionalizing one or more of the chain ends of a polymer rather than the polymer backbone. As a general overview, the method may include the steps of: forming a polymer with at least one living chain end, or in an embodiment, two living chain ends; and terminating the living chain end or ends with a reactive compound containing silane functionality or a reactive compound which yields a reactive group capable of further being derivatized into a silane functional group.

In a first step a polymer with two living chain ends is formed. In one embodiment, the polymer is formed using an anionic difunctional initiator. The polymerization may be carried out under conditions effective to provide a living anionic polymerization. Non-limiting examples of suitable di lithio initiators and their use in preparing polymers may be found in Czech Republic patents CS229066 B1 and CS223252 B1, the contents of both f which are incorporated by reference herein in their entireties.

In a second step, the living chain ends of the terminal silane modified polymer are terminated with at least one of a reactive compound containing silane functionality or a reactive compound which provides a reactive group (such as a hydroxyl group) capable of being further derivatized into a silane functional group (by reaction with an isocyanate-functionalized silane, for example). Without wishing to be bound by theory, polymers of relatively low molar mass, terminal silane functionality may also effectively “tie down” the chain ends on a filler surface or through intermolecular condensation reactions, reducing another contribution to energy loss via chain-end motion upon dynamic strain. The inventors discovered that functionalizing the terminal groups, as disclosed herein, provides a more effective reduction in heat build-up in tire compounds than functionalizing by way of grafting to the backbone, which leave the chain ends unaffected.

This method of preparing the terminal silane functionalized polymer advantageously enables the silane-functional polymer to be added/mixed with the silica composition in situ during compound mixing, rather than pre-blending or pre-reacting a silane coupling agent with the silica filler, which provides additional advantages by reducing the number of steps involved in the compounding process.

As another advantage, various methods may be employed to produce the terminal silane modified polymer of the present invention. A first process includes producing a polymer of conjugated diene and vinyl aromatic monomers by anionic polymerization and capping the living end(s) of the polymer with a silane ester such as tetraethoxysilane instead of protons. A second process is to react the living anionic polymer chain end(s) with an alkylene oxide (e.g., ethylene oxide, propylene oxide) followed by a proton source, producing hydroxyl-terminated polymers. The hydroxyl-terminated polymer can then be reacted with isocyanatosilanes (e.g., 3-(triethoxysilyl)propyl isocyanate or 3-isocyanatopropyltriethoxysilane) to form the silane-terminated polymer. In a third process, the terminal hydroxyl groups of the terminal hydroxyl modified polymer can be reacted with a diisocyanate, which can further react with aminosilanes producing the desired result.

Non-limiting examples of conjugated diene monomers suitable for use as a monomer in the silane terminated copolymer are conjugated diene monomers having 4 to 12 carbon atoms and/or copolymers obtained by copolymerization of one or more conjugated dienes with each other or with one or more vinyl aromatic compounds having 8 to 20 carbon atoms.

Suitable conjugated dienes include 1,3-butadiene, 2-methyl-1,3-butadiene, 2,3-di(C1-C5 alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, aryl-1,3-butadienes, 1,3-pentadiene 2,4-hexadiene, and mixtures thereof.

Suitable vinyl aromatic compounds suitable for use as a monomer in the silane terminated copolymer are, for example, styrene, ortho-, meta- and para-methyl styrene, alpha methyl styrene, the commercial mixture “vinyltoluene”, para-t-butylstyrene, methoxystyrenes, chlorostyrenes, vinylmesitylene, divinylbenzene, vinylnaphthalene, and combinations thereof.

According to certain embodiments, the silane terminated copolymer includes at least 5 wt % of the vinyl aromatic monomer. According to some embodiments the silane terminated copolymer includes from 5 wt % to 60 wt % of the vinyl aromatic monomer. For example, the silane terminated copolymer may include from 10 wt % to 50 wt %, or from 15 wt % to 45 wt %, or from 20 wt % to 40 wt %, or from 20 wt % to 30 wt %, or from 25 wt % to 35 wt %, of the vinyl aromatic monomer.

According to certain embodiments, the vinyl content of the silane terminated copolymer may be 20 wt % or more, or 50 wt % or more. For example, the vinyl content of the silane terminated copolymer may be 15 wt % or more, 20 wt % or more, 25 wt % or more, 30 wt % or more, 35 wt % or more, 40 wt % or more, or 45 wt % or more or 55 wt % or more or 60 wt % or more.

According to certain the embodiments, the silane terminated copolymer has a number average molecular weight (Mn) of from 1,000 g/mol to 40,000 g/mol (Da). The Mn of the silane terminated copolymer may be from 1,000 g/mol to 25,000 g/mol, from 2000 g/mol to 10,000 g/mol, from 2,500 g/mol to 10,000 g/mol, from 1,000 g/mol to 10,000 g/mol, from 3,000 g/mol to 5,000 g/mol, from 1,500 g/mol to 3,000 g/mol.

The silane terminated copolymers may, for example, be block, statistical (random), sequential or micro-sequential polymers. Random polymers may not be necessarily completely random and may contain some areas of blockiness, i.e. regions of the chain having only one of the monomers.

The silane functionality of the silane terminated copolymer may be 2 or less, and may be from 0.5 to 2, 0.55 to 2, 0.6 to 2, 0.65 to 2, 0.7 to 2, 0.75 to 2, 0.8 to 2, 0.85 to 2, 0.9 to 2, 0.95 to 2, 1 to 2, 1.05 to 2, 1.1 to 2, 1.15 to 2, 1.2 to 2, 1.25 to 2, 1.3 to 2, 1.35 to 2, 1.4 to 2, 1.45 to 2, 1.5 to 2, 1.55 to 2, 1.6 to 2, 1.65 to 2, 1.7 to 2, 1.75 to 2, 1.8 to 2, 1.85 to 2, 1.9 to 2, or from 1.95 to 2, i.e., the chains may range from having only one end terminated with a silane functionality to most of the chains having silane functionality at both ends. The silane functionality may be —Si(OR)₃, where each R is independently a C1-C6 alkyl group or an aryl group, or an H. Each R may be a methyl group, an ethyl group, a propyl group, a phenyl group or combinations thereof. Each R may be an ethyl group. The silane functionality may be attached to the polymer terminal end by a linking group, for example a urethane linkage.

In some embodiments, other co-monomers may be included in the silane terminated copolymer in addition to the conjugated diene and the vinyl aromatic monomer. The co-monomers may be selected from monomers having at least one double bond, for example farnesene, myrcene, isoprene, (meth)acrylates, acrylonitrile, ethylene, propylene, and combinations thereof.

High Molecular Weight Elastomers Different from the Silane Terminated Copolymer: One or more high molecular weight diene elastomers are utilized in compositions of the present invention. It is understood that these high molecular weight elastomers are different from the relatively lower molecular weight silane terminated copolymer described above. Suitable diene elastomers for this purpose are generally high in molecular weight (e.g., a number average molecular weight Mn above 80,000 g/mol) and contain sites of residual unsaturation which are capable of being cured (crosslinked) when the composition is heated to a sufficiently high temperature. The high molecular weight elastomers may have a number average molecular weight of from 50,000 g/mol to 2,000,000 g/mol, or from 60,000 g/mol to 1,600,000 g/mol, or from 75,000 g/mol to 1,500,000 g/mol, or from 80,000 g/mol to 1,200,000 g/mol, or from 80,000 g/mol to 1,750,000 g/mol, or from 80,000 g/mol to 900,000 g/mol, or from 60,000 g/mol to 850,000 g/mol, or from 80,000 g/mol to 500,000 g/mol, or from 75,000 g/mol to 150,000 g/mol, for example. The number average molecular weight of these high molecular weight elastomers may be above 75,000 g/mol, 100,000 g/mol, 200,000 g/mol, 300,000 g/mol, 400,000 g/mol, 500,000 g/mol, 600,000 g/mol, 700,000 g/mol, 800,000 g/mol, 900,000 g/mol, 1,100,000 g/mol, 1,200,000 g/mol, 1,300,000 g/mol, 1,400,000 g/mol, 1,500,000 G/mol, 1,600,000 g/mol, 1,700,000 G/mol, 1,800,000 g/mol, 1,900,000 g/mol, or above 2,000,000 g/mol for example. In the context of the present invention, “diene elastomer” is understood to mean an elastomer (rubber) resulting at least in part from the polymerization of one or more diene monomers (monomers bearing two double carbon-carbon bonds, whether conjugated or not). Suitable diene elastomers include both homopolymers and copolymers. The high molecular weight diene elastomer(s) may be functionalized. A diene elastomer suitable for use in the curable rubber compositions according to the invention may be “highly unsaturated,” such as a polymer obtained from conjugated diene monomers which has a greater than 50% molar content of polymerized units of conjugated diene monomers.

According to one embodiment of the invention, the curable rubber composition may comprise one or more diene elastomers having a Tg between −110° C. and −40° C. Mixtures of diene elastomers having different glass transition temperatures may also be employed. For example, the curable rubber composition may comprise a first diene elastomer having a Tg of from −110° C. to −75° C. and a second diene elastomer having a Tg different from that of the first diene elastomer and in the range of from −75° C. to −40° C.

According to various aspects, highly unsaturated diene elastomers are utilized, in particular homopolymers obtained by homopolymerization of a conjugated diene monomer having 4 to 12 carbon atoms and/or copolymers obtained by copolymerization of one or more conjugated dienes with each other or with one or more vinyl aromatic compounds having 8 to 20 carbon atoms.

Suitable conjugated dienes are, for example, 1,3-butadiene, 2-methyl-1,3-butadiene, 2,3-di(C1-C5 alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, aryl-1,3-butadienes, 1,3-pentadiene and 2,4-hexadiene. Suitable vinyl aromatic compounds are, for example, styrene, alpha methyl styrene, ortho-, meta- and para-methyl styrene, the commercial mixture “vinyltoluene”, para-t-butylstyrene, methoxystyrenes, chlorostyrenes, vinylmesitylene, divinylbenzene and vinylnaphthalene and combinations thereof.

The copolymers may, for example, contain between 99% and 20% by weight of diene units (in bound/polymerized form) and between 1% and 80% by weight of vinyl aromatic units (in bound/polymerized form). The elastomers may have any microstructure, which is a function of the polymerization conditions used, in particular of the presence or absence of a modifying and/or randomizing agent and the quantities of modifying and/or randomizing agent used. The elastomers may, for example, be block, statistical (random), sequential or micro-sequential elastomers, and may be prepared in dispersion or in solution; they may be coupled and/or starred or alternatively functionalized with a coupling and/or starring or functionalizing agent.

Particular embodiments of the present invention use polybutadienes, including those having a content of 1,2-units between 4% and 80%, or those having a content of cis-1,4 (bonds) of more than 80%, polyisoprenes, butadiene-styrene copolymers, including those having a styrene content of between 5% and 50% by weight and more particularly, between 20% and 40%, a content of 1,2-bonds of the butadiene fraction of between 4% and 65%, and a content of trans-1,4 bonds of between 20% and 80%, butadiene-isoprene copolymers including those having an isoprene content of between 5% and 90% by weight and a glass transition temperature of between −40° C. and −80° C., isoprene-styrene copolymers and in particular those having a styrene content of between 5% and 50% by weight and a Tg of between −25° C. and −50° C. In the case of butadiene-styrene-isoprene copolymers, those that are suitable include, but are not limited to, those having a styrene content of between 5% and 50% by weight and more particularly, between 10% and 40%, an isoprene content of between 15% and 60% by weight, and more particularly between 20% and 50%, a butadiene content of between 5% and 50% by weight, and more particularly between 20% and 40%, a content of 1,2-units of the butadiene fraction of between 4% and 85%, a content of trans-1,4 units of the butadiene fraction of between 6% and 80%, a content of 1,2-plus 3,4-units of the isoprene fraction of between 5% and 70%, and a content of trans-1,4 units of the isoprene fraction of between 10% and 50%, and more generally any butadiene-styrene-isoprene copolymer having a Tg of between −20° C. and −70° C.

The diene elastomer(s) of the composition according to particular embodiments of the present invention may be selected from the group of highly unsaturated diene elastomers that include polybutadienes (BR), synthetic polyisoprenes (IR), natural rubber (NR), butadiene copolymers, isoprene copolymers and mixtures thereof.

Such copolymers may, in other embodiments, be selected from the group that includes butadiene-styrene copolymers (SBR), butadiene-isoprene copolymers (BIR), isoprene-styrene copolymers (SIR), isoprene-butadiene-styrene copolymers (SBIR) and mixtures thereof.

The curable rubber compositions used to prepare tires and other products in accordance with the invention may contain a single diene elastomer or a mixture of several diene elastomers, the diene elastomer(s) possibly being used in association with any type of synthetic elastomer other than a diene elastomer, or even with polymers other than elastomers, for example thermoplastic polymers.

The high molecular weight diene-based elastomers may be selected from the group consisting of polybutadienes, polyisoprenes, copolymers of butadiene and vinyl aromatic monomers, copolymers of isoprene and vinyl aromatic monomers, and combinations of two or more such diene elastomers. For example, elastomers that may be used in the present invention include styrene-isoprene-butadiene rubber (SIBR), styrene-isoprene rubber (SIR), isoprene-butadiene rubber (IBR). Natural rubber can also be used in addition to synthetic rubbers which may include neoprene (polychloroprene), polybutadiene (including cis 1,4-polybutadiene), polyisoprene (including cis-1,4-polyisoprene), butyl rubber, halobutyl rubber such as chlorobutyl rubber or bromobutyl rubber, acrylonitrile and methyl methacrylate rubbers, as well as ethylene/propylene terpolymers, also known as ethylene/propylene/diene monomer (EPDM), and in particular, ethylene/propylene/dicyclopentadiene terpolymers. Additional examples of rubbers which may be used include carboxylated rubbers, as well as silicon-coupled and tin-coupled star-branched polymers.

In one embodiment, the curable rubber composition includes at least one polybutadiene having a relatively high 1,4-cis content, e.g., a 1,4-cis content of at least 80%, at least 85% or at least 90%. In another embodiment, the curable rubber composition is comprised of at least one styrene/butadiene rubber, in particular a solution polymerized styrene/butadiene rubber. The bound styrene content of such a copolymer may be from 15 to 30% by weight, for example. The curable rubber composition may comprise both types of diene elastomer, e.g., at least one high 1,4-cis content polybutadiene and at least one solution-polymerized styrene/butadiene rubber. The content of high 1,4-cis butadiene rubber may be, for example, from 15 to 35 phr and the content of solution-polymerized styrene/butadiene rubber may be, for example, from 65 to 85 phr.

Examples of reinforcing fillers that may be included in the curable rubber compositions according to certain embodiments of the present invention include pyrogenic silica fillers and precipitated finely-divided silicas typically employed for rubber compounding. The silica filler may be of the type obtained by precipitation from a soluble silicate, such as sodium silicate. For example, silica fillers may be produced according to the method described in U.S. Pat. No. 2,940,830, which is incorporated herein in its entirety for all purposes. The precipitated, hydrated silica pigments may have a SiO₂ content of at least 50% and usually greater than 80% by weight on an anhydrous basis. The silica filler may have an ultimate particle size in the range of from about 50 to 10,000 angstroms, between 50 and 400 or between 100 and 300 angstroms. The silica may have an average ultimate particle size in a range of about 0.01 to 0.05 microns as determined by electron microscope, although the silica particles may even be smaller in size. The Brunauer-Emmett-Teller (“BET”) surface area of the filler as measured using nitrogen gas may be in the range of 40 to 600 square meters per gram, or in the range of 50 to 300 square meters per gram. The BET method of measuring surface area is described in the Journal of the American Chemical Society, Vol. 60, page 304 (1930). The silica also may have a dibutyl (“DBP”) absorption value in a range of about 200 to about 400, or in a range of from about 220 to 300.

Various commercially available silicas and carbon black may be used as reinforcing fillers in various embodiments of the present invention. Suitable types of carbon black include, but are not limited to, super abrasion furnace, intermediate SAF, high abrasion furnace, easy processing channel, fast extruding furnace, high modulus furnace, semi-reinforcing furnace, fine thermal, and/or medium thermal carbon blacks. For example, silicas commercially available from PPG Industries under the Hi-Sil trademark such as, for example, those with designations 210, 243, etc.; silicas available from Rhone-Poulenc, with designations of Z1165MP and Z165GR and silicas available from Degussa AG with designations VN2 and VN3, etc. may be used. The Rhone-Poulenc Z1165MP silica is an example of a silica, which is reportedly characterized by having a BET surface area of about 160-170, a DBP value of about 250-290, and a substantially spherical shape. Suitable examples of carbon blacks include, but are not limited to, N110, N121, N220, N231, N234, N242, N293, N299, S315, N326, N330, N332, N339, N343, N347, N351, N358, N375, N539, N550, N582, N630, N642, N650, N683, N754, N762, N765, N774, N787, N907, N908, N990 and N991. While carbon black is optional, tire formulations generally include it.

Representative reinforcing fillers may be included in rubber compositions according to various embodiments of the invention in amounts ranging from about 5 to 100 parts by weight of reinforcing fillers per 100 parts by weight of the total rubber composition (phr). For example, between about 10 and 50 parts by weight of reinforcing filler is used per 100 parts of rubber.

In compounding a rubber composition containing a filler, one generally uses a coupling agent. Silane coupling agents may be used. Such coupling agents, for example, may be premixed or pre-reacted with the filler or added to the rubber mix during the rubber/filler processing or mixing stage. If the coupling agent and filler are added separately to the rubber mix during the rubber/filler mixing or processing stage, it is considered that the coupling agent then combines in situ with the filler. Any coupling agents known to those of skill in the art may be employed in compositions of the present invention. Coupling agents are generally composed of a coupling agent which has a constituent silane component (i.e. moiety) capable of reacting with the silica surface and, also, a constituent component capable of reacting with the rubber. The coupling agent may be capable of reacting with a sulfur-vulcanizable rubber, which contains carbon-to-carbon double bonds, or unsaturation. In this manner, the coupler (coupling agent) may act as a connecting bridge between the silica and the rubber and, thereby, enhance the rubber reinforcement aspect of the silica.

The silane of the coupling agent may form a bond to the silica surface, possibly through hydrolysis, and the rubber reactive component of the coupling agent combines with the rubber itself. Usually the rubber reactive component of the coupler is temperature sensitive and tends to combine with the rubber during the final and higher temperature sulfur vulcanization stage. However, some degree of combination or bonding may occur between the rubber-reactive component of the coupler and the rubber during an initial rubber/silica/coupler mixing stage prior to a subsequent vulcanization stage. Silane coupling agents can be used in rubber mixtures to improve the processability and to bind the silica filler and other optionally present polar fillers to the diene rubber. Here, one or more different silane coupling agents can be used in combination with one another. The rubber mixture can thus contain a mixture of different silanes.

The silane coupling agents may react with the surface silanol groups of the silica filler or other polar groups during the mixing of the rubber or the rubber mixture (in situ). Suitable silane coupling agents can be all the silane coupling agents known to one skilled in the art for use in rubber mixtures. Such coupling agents known from the prior art are bifunctional organosilanes which have at least one alkoxy, cycloalkoxy or phenoxy group on the silicon atom as the leaving group and which, as other functionality, have a group which, if appropriate, can undergo a chemical reaction with the double bonds of the polymer after cleavage. The last-mentioned group can, for example, be the following chemical groups: SCN, —SH, —NH₂ or —Sₓ— (with x=2 to 8). The following are thus suitable as silane coupling agents, for example, (3-mercaptopropyl)triethoxysilane, (3-thiocyanatopropyl)trimethoxysilane or 3,3′-bis(triethoxysilylpropyl) polysulphides with 2 to 8 sulphur atoms, for example, 3,3′-bis(triethoxysilylpropyl) tetrasulphide (TESPT), the corresponding disulphide (TESPD), or also mixtures of the sulphides with 1 to 8 sulphur atoms with different contents of the various sulphides. TESPT can, for example, also be added as a mixture with an industrial carbon black (trade name X505® from Evonik). For example, a silane mixture which contains 40 to 100 wt % of disulphides, or 55 to 85 wt % of disulphides, or 60 to 80 wt % of disulphides may be used. Such a mixture is, for example, obtainable under the trade name Si 261° from Evonik which, for example, is described in DE 102006004062, the disclosure of which is incorporated by reference herein in its entirety.

Blocked mercaptosilanes such as, for example, from WO 99/09036, the disclosure of which is incorporated by reference herein in its entirety, can also be used as silane coupling agents. Silanes such as are described in WO 2008/083241 A1, WO 2008/083242 A1, WO 2008/083243 083243A1, and WO 2008/083244 A1, the disclosures of all of which are incorporated by reference herein in their entireties, can also be used. Silanes which can be used, for example, are known by the name NXT (e.g., (3-(octanoylthio)-1-propyl)triethoxysilane) in various variants are marketed by the Momentive company, USA, or by the name VP Si 363° marketed by Evonik Industries.

The rubber composition may also contain conventional additives in addition to reinforcing fillers, including other fillers, peptizing agents, pigments, stearic acid, accelerators, sulfur vulcanizing agents, antiozonants, antioxidants, processing oils, activators, initiators, plasticizers, waxes, prevulcanization inhibitors, extender oils and the like.

Examples of sulfur vulcanizing agents include, but are not limited to, elemental sulfur (free sulfur) or sulfur donating vulcanizing agents, for example, an amine disulfide, polymeric polysulfide or sulfur olefin adducts. The amount of sulfur vulcanizing agent will vary depending on the type of rubber and particular type of sulfur vulcanizing agent, but generally range from about 0.1 phr to about 5 phr with a or from about 0.5 phr to about 2 phr.

Examples of antidegradants (antioxidants) that may be in a rubber composition according to various embodiments of the present invention include, but are not limited to, monophenols, bisphenols, thiobisphenols, polyphenols, hydroquinone derivatives, phosphites, phosphate blends, thioesters, naphthylamines, diphenol amines as well as other diaryl amine derivatives, para-phenylene diamines, quinolines and blended amines. Antidegradants are generally used in an amount ranging from about 0.1 phr to about 10 phr or a range of from about 2 to 6 phr.

Examples of a peptizing agent include, but are not limited to, pentachlorophenol, which may be used in an amount ranging from about 0.1 phr to 0.4 phr, or a range of from about 0.2 to 0.3.

Examples of processing oils include, but are not limited to, aliphatic-naphthenic aromatic resins, polyethylene glycol, petroleum oils, ester plasticizers, vulcanized vegetable oils, pine tar, phenolic resins, petroleum resins, distillate aromatic extract (DAE) oil, polymeric esters and rosins. Processing oils may be used in an amount ranging from about 0 to about 50 phr, or from about 5 to 35 phr.

An example of an initiator includes, but is not limited to, stearic acid. Initiators may be used in an amount ranging from about 1 to 4 phr, or a range of from about 2 to 3 phr.

Examples of accelerators include, but are not limited to, amines, guanidines, thioureas, thiols, thiurams, disulfides, thiazoles, sulfenamides, dithiocarbamates, and xanthates. In cases where only a primary accelerator is used, the amounts used may range from about 0.5 to 2.5 phr. In cases where combinations of two or more accelerators are used, the primary accelerator may be used in amounts ranging from 0.5 to 2.0 phr and the secondary accelerator may be used in amounts ranging from about 0.1 to 0.5 phr. Combinations of accelerators have been known to produce a synergistic effect. The primary accelerator may be a sulfenamide. If a secondary accelerator is used, it is may be a guanidine, a dithiocarbamate, and/or a thiuram compound.

The rubber compositions according to embodiments of the present invention may be compounded by conventional means known by those having skill in the art, including a mixer or compounder (such as a Banbury® mixer), mill, extruder, etc. The tires may be built, shaped, molded, and cured by various methods which will also be readily apparent to those having skill in such art.

To cure the curable rubber compositions of the present invention, any of the usual vulcanization or curing processes known in the art may be used such as heating with superheated steam or hot air in a press or mold. Accordingly, the curable rubber composition may be cured by a process comprising heating the curable rubber composition, which may be molded into a desired form, at a temperature and for a time effective to cure the diene elastomer(s).

Particular embodiments of the present invention include tires, in particular tire treads, that are intended for passenger-car or light truck tires but the invention is not limited only to such tires. It is noted that the particular embodiments of the tires of the present invention are intended to be fitted on motor vehicles (including passenger vehicles) or non-motor vehicles such as bicycles, motorcycles, racing cars, industrial vehicles such as vans, heavy vehicles such as buses and trucks, off-road vehicles such as agricultural, mining, and construction machinery, aircraft or other transport or handling vehicles.

The curable rubber compositions disclosed herein may be used for various rubber products such as tires, particularly a tread compound, and in other components for tires, industrial rubber products, seals, timing belts, power transmission belting, and other rubber goods. As such, the present invention includes products made from the curable rubber compositions disclosed herein.

The silane terminated copolymers disclosed herein may be used in reactive adhesives, coatings, and sealants for example.

Within this specification, embodiments have been described in a way which enables a clear and concise specification to be written, but it is intended and will be appreciated that embodiments may be variously combined or separated without departing from the invention. For example, it will be appreciated that all features described herein are applicable to all aspects of the invention described herein.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

Various non-limiting aspects of the invention are summarized below.

Aspect 1: A curable rubber composition comprising:

a high molecular weight diene elastomer;

a silica composition;

an optional carbon black composition; and

a silane terminated copolymer different from the high molecular weight diene elastomer comprising, as polymerized units, monomers comprising conjugated dienes and vinyl aromatics, the silane terminated copolymer having at least one terminal end modified with at least one silane group.

Aspect 2: The curable rubber composition according to Aspect 1, comprising the carbon black composition.

Aspect 3: The curable rubber composition of either Aspect 1 or Aspect 2, wherein the silane terminated copolymer is a random copolymer.

Aspect 4: The curable rubber composition of any of Aspects 1-3, wherein the silane terminated copolymer has a number average molecular weight of from 1,000 g/mol to 40,000 g/mol.

Aspect 5: The curable rubber composition of any of Aspects 1-3, wherein the silane terminated copolymer has a number average molecular weight of from 1,000 g/mol to 25,000 g/mol.

Aspect 6: The curable rubber composition of any of Aspects 1-3, wherein the number average molecular weight of the silane terminated copolymer is 1000 g/mol to 10,000 g/mol.

Aspect 7: The curable rubber composition of any of Aspects 1-6, wherein the silane terminated copolymer comprises at least 5 wt % of the vinyl aromatics monomer.

Aspect 8: The curable rubber composition of any of Aspects 1-6, wherein the silane terminated copolymer comprises from 5 wt % to 60 wt % of the vinyl aromatics monomer.

Aspect 9: The curable rubber composition of any of Aspects 1-8 wherein the vinyl aromatics monomer comprises styrene.

Aspect 10: The curable rubber composition of any of Aspects 1-9 wherein the conjugated diene comprises butadiene.

Aspect 11: The curable rubber composition of any of Aspects 1-10, wherein the silane terminated copolymer comprises a vinyl content of 20% by weight or more.

Aspect 12: The curable rubber composition of any of Aspects 1-10, wherein the silane terminated copolymer comprises a vinyl content of 50% by weight or more.

Aspect 13: The curable rubber composition of any of Aspects 1-12, wherein the silica composition is a precipitation product of soluble silicate.

Aspect 14: The curable rubber composition of any of Aspects 1-13, further comprising at least one silane coupling agent.

Aspect 15: The curable rubber composition of any of Aspects 1-14, wherein the silane group of the silane terminal polymer is represented by the following formula: —Si(OR)₃, where each R is independently a C1-C6 alkyl group or an aryl group, or an H.

Aspect 16: The curable rubber composition of any of Aspects 1-15, wherein the silane group of the silane terminal polymer is represented by the following formula: —Si(OR)₃, where each R is an ethyl group.

Aspect 17: The curable rubber composition of any of Aspects 1-16, wherein the silane terminated copolymer is produced via anionic polymerization.

Aspect 18: The curable rubber composition of any of Aspects 1-17, wherein the silane terminated copolymer has a silane functionality of 2 or less.

Aspect 19: The curable rubber composition of any of Aspects 1-17, wherein the silane terminated copolymer has a silane functionality of from 0.8 to 2.

Aspect 20: The curable rubber composition of any of Aspects 1-19, wherein the high molecular weight diene elastomer has a number average molecular weight of above 75,000 g/mol.

Aspect 21: A tire comprising a cured rubber composition comprised of:

a high molecular weight diene elastomer;

a silica composition;

an optional carbon black composition; and

a silane terminated copolymer different from the high molecular weight diene elastomer comprising, as polymerized units, monomers comprising conjugated dienes and vinyl aromatics, the silane terminated copolymer having at least one terminal end modified with at least one silane group.

Aspect 22: The tire of Aspect 21, wherein the cured rubber composition comprises the carbon black composition.

Aspect 23: The tire of either Aspect 21 or Aspect 22, wherein the silane terminated copolymer is a random copolymer.

Aspect 24: The tire of any of Aspects 21-23, wherein the silane terminated copolymer has a number average molecular weight of from 1,000 g/mol to 40,000 g/mol.

Aspect 25: The tire of any of Aspects 21-23, wherein the silane terminated copolymer has a number average molecular weight of from 1,000 g/mol to 25,000 g/mol.

Aspect 26: The tire of any of Aspects 21-23, wherein the silane terminated copolymer has a number average molecular weight of from 2000 g/mol to 10,000 g/mol.

Aspect 27: The tire of any of Aspects 21-26, wherein the silane terminated copolymer has a silane functionality of 2 or less.

Aspect 28: The tire of any of Aspects 21-26, wherein the silane terminated copolymer has a silane functionality of from 0.8 to 2.

Aspect 29: The tire of any of Aspects 21-27, wherein the cured rubber composition has a Tg of −20° C. or higher.

Aspect 30: The tire of any of Aspects 21-29, wherein the silane terminated copolymer comprises at least 5 wt % of the vinyl aromatics monomer.

Aspect 31: The tire of any of Aspects 21-29, wherein the silane terminated copolymer comprises from 5 wt % to 60 wt % of the vinyl aromatics monomer.

Aspect 32: The tire of any of Aspects 21-31, wherein the vinyl aromatics monomer comprises styrene.

Aspect 33: The tire of any of Aspects 21-32, wherein the conjugated diene comprises butadiene.

Aspect 34: The tire of any of Aspects 21-33, wherein the silane terminated copolymer comprises a vinyl content of 20% by weight or more.

Aspect 35: The tire of any of Aspects 21-33, wherein the vinyl content of the silane terminated copolymer is 50 wt % or more.

Aspect 36: The tire of any of Aspects 21-35, wherein the silica composition is obtained from precipitation of soluble silicate.

Aspect 37: The tire of any of Aspects 21-36, further comprising at least one silane coupling agent.

Aspect 38: The tire of any of Aspects 21-37, wherein the silane group of the silane terminal polymer is represented by the following formula: —Si(OR)₃, where each R is independently a C1-C6 alkyl group or an aryl group, or an H.

Aspect 39: The tire of any of Aspects 21-38, wherein the silane group of the silane terminal polymer is represented by the following formula: —Si(OR)₃, where each R is an ethyl group.

Aspect 40: The tire of any of Aspects 21-39, wherein the silane terminated copolymer is produced via anionic polymerization.

Aspect 41: The tire of any of Aspects 21-40, wherein the curable rubber composition has been cured using at least one sulfur vulcanizing agent.

Aspect 42: The tire of any of Aspects 21-41, wherein the cured rubber composition has a peak tan δ of 0° C. or higher.

Aspect 43: The tire of any of Aspects 21-42, wherein the cured rubber composition has a tan δ at 0° C. of 0.30 or higher, a tan δ at 25° C. of 0.010 or higher and a tan δ at 60° C. of 0.5 or lower.

Aspect 44: The tire of any of Aspects 21-43, wherein the high molecular weight diene elastomer has a number average molecular weight of above 75,000 g/mol.

Aspect 45: A method for producing a rubber composition adapted for use in a tire, the method comprising:

forming a composition by mixing a silica composition, a high molecular weight diene elastomer, optionally a carbon black composition, a silane terminated copolymer different from the high molecular weight diene elastomer comprising, as polymerized units, monomers comprising conjugated dienes and vinyl aromatics, the silane terminated copolymer having at least one terminal end modified with at least one silane group; and

curing the composition.

Aspect 46: The method of Aspect 45, wherein the composition includes the carbon black composition.

Aspect 47: The method of either Aspect 45 or Aspect 46, wherein the silane terminated copolymer has a number average molecular weight of from 1,000 g/mol to 40,000 g/mol.

Aspect 48: The method of either Aspect 45 or Aspect 46, wherein the silane terminated copolymer is a random copolymer.

Aspect 49: The method of any of Aspects 45-48, wherein the silane terminated copolymer is polymerized by living anionic polymerization.

Aspect 50: The method of any of Aspects 45-49, wherein the silane terminated copolymer has been prepared by a process comprising modifying at least one terminal end of the silane terminated copolymer to have a silane group.

Aspect 51: The method of any of Aspects 45-50, wherein the process for preparing the silane terminated copolymer further comprises modifying at least one terminal end of the living silane terminated copolymer by reacting the silane terminated copolymer with an alkylene oxide followed by a proton source to produce a hydroxyl-terminated silane terminated copolymer.

Aspect 52: The method of any of Aspects 45-51, wherein the process for preparing the silane terminated copolymer further comprises modifying at least one terminal end of the silane terminated copolymer by converting the terminal hydroxyl group to a silane group on the silane terminated copolymer.

### EXAMPLES

In order that the invention may be more fully understood, the following non-limiting examples are provided by way of illustration only.

Various rubber compositions were prepared containing the constituents in the proportions provided by Table 2. For the compound mixing and testing step, elastomeric poly(butadiene) (cis-BR, Buna® BR22) and solution poly(styrene-co-butadiene) (SSBR, Buna® VSL VP PBR 4041) were used as produced by Arlanxeo Performance Elastomers. An N330-grade carbon black (N330 CB, Vulcan® 3) was supplied by Cabot, and precipitated silica (Zeosil® ZS 1165MP) was acquired from Solvay. Aromatic oil (DAE oil, Sundex® 790TN) was produced by Sunoco Inc. N-isopropyl-N′-phenyl-p-phenylenediamine (Santoflex® IPPD) antioxidants and the accelerator N-t-butylbenzothiazole-2-sulfenamide (Santocure® TBBS), were commercial products of Flexsys America L.P. Redball® Rubbermaker's sulfur was provided by International Sulphur Inc. The zinc oxide and stearic acid used in the study were supplied by Sigma-Aldrich Company.

### Compounding Procedure

Each compounded stock was mixed in a 350 cc internal mixer with cam blades (Brabender® Prep-Mixer®). Three-stage mixing was used for each compound The compounds were calendered in between mixing stages using a lab scale two roll mill (Reliable Rubber and Plastic Machinery, 6″×13″ variable speed drive, Model 5025). Blends were removed and allowed to cool overnight prior to curing and analysis. For stage 1, initial mixer conditions were 100° C. and 60 rpm, and after the elastomers, the silane-terminated copolymers or non-functional polymers, silica and silane coupling agent were added to the mixer, the temperature was allowed to increase to 150° C., at which point the rotational speed was adjusted to maintain a 150° C.<T<160° C. for five minutes. Stage 2 initial mixer conditions were the same as stage 1, and after the compound from stage 1 was added, it was allowed to mix for 3 minutes. Productive stage 3 initial conditions were 60° C. and 60 rpm, and after the compound from stage 2 and the vulcanization ingredients were added, they were allowed to mix for 3 minutes or until a compound temperature of 110° C. was reached.

### Polymer Testing

Molecular Characterization. Standard size exclusion chromatography (SEC) was utilized to determine molecular weight (number average, Mn and weight average, Mw) and molecular weight distributions of the polymer samples on an Agilent 1260 Infinity instrument in tetrahydrofuran (THF) using a guard column followed by two Agilent ResiPore columns in series with refractive index detection. Number average molecular weight (Mn) values for the high molecular weight diene elastomers [poly(butadienes)] were determined using an in-house poly(butadiene) calibration curve. The values for the Mn values of the silane terminated copolymer different from the high molecular weight diene elastomer were determined using poly(styrene) calibration standards. While it is known that the choice of calibration standards can affect the reported molar mass, especially if structural differences between the calibration polymer and measured polymer exist, this technique has been chosen as it is a common practice.

Diol Content. High-performance liquid chromatography (HPLC) was utilized to determine diol content (F2) of hydroxyl terminated polymers. Agilent 1260 instrument in n-hexane 99.5% wt. and 0.5% wt. isopropyl alcohol using NUCLEOSIL® 1000NH2 column in series with refractive index detector (RID). Retention time of polymer on column increases with amount of hydroxyl groups on polymer molecule. Diol content is calculated as ratio of peak area representing polymer diol to total peak area.

Vinyl Content. Vinyl content was determined by Fourier transform infrared (FTIR) spectrometry using a Nicolet 380FTIR instrument equipped with an attenuated total reflectance (ATR) sensor. To calibrate the instrument a set of NMR evaluated standards was used.

### Performance Testing

Physical testing was performed on samples cured in a press to t90 times (time to 90% of maximum torque, optimal cure) at 160° C. A Dynamic Mechanical Analyzer (DMA 2980, TA Instruments) was operated in tension to obtain temperature sweeps of the cured vulcanizates from −100° C. to 100° C. at 10 Hz and 0.1% strain amplitude. Tangent δ at 0° C. (or rebound at 23° C.) was used as a lab indicator for wet traction properties. A higher tan δ at 0° C. (or lower rebound at 23° C.) means improved wet traction properties. Tangent δ at 60° C. (or rebound at 70° C.) was used as a lab indicator for rolling resistance (also called fuel consumption). A lower tan δ at 60° C. (or higher rebound at 70° C.) means improved rolling resistance properties. The rebound test is performed according to ISO 4662 rubber protocol.

### Example 1: Preparation of Polymers

A hydroxyl terminated polystyrene-polybutadiene-polystyrene block copolymer (Polymer 1) was prepared in glass reactor equipped by agitator and cooling coil. Polymerization reaction was carried under an inert atmosphere of nitrogen. The reactor was charged with 2495 g polymerization solvent methyl tert-butyl ether (MTBE), and 379 g (alkalinity 0.921 mmol/g) of di lithio initiator. Butadiene (344 g) was then dosed gradually into the solvent and polymerization temperature was maintained at 30° C. After all the butadiene was added, 147 g of styrene was added to the reactor. After dosing all monomer, 59 g (4 molar equivalent to lithium) of ethylene oxide was added into the reactor. The reaction mixture was then hydrolyzed by adding 25 mL of distilled water. Obtained Polymer 1 solution was mixed with 500 mL of distilled water. After phase separation, the water layer was removed. The washing step was repeated until the water layer became neutral (pH=7). The polymer solution was then transferred to a three necked flask for product isolation. After removing the MTBE by distillation, residual solvent was removed by nitrogen stripping at 120° C. The isolated material was cooled down to approximately 70° C. and transferred to a container. This hydroxyl-terminated polymer was then reacted with 3-(triethoxysilyl)propyl isocyanate to provide a silane terminated block styrene-butadiene-styrene copolymer according to the invention. In later sections this sample is referred to as SBS-Fn2.

A hydroxyl terminated styrene-butadiene random copolymer (Polymer 2) was prepared in a glass reactor equipped with an agitator and cooling coil. The polymerization reaction was carried out under an inert nitrogen atmosphere. The reactor was charged with 545 g of MTBE as solvent and 341 g of di lithio initiator (alkalinity 0.941 mmol/g). A mixture of monomers containing 30% wt. Styrene and 70% wt. butadiene was then gradually dosed into the reactor while maintaining the reaction temperature at 30° C. The total dose of monomer mixture was 465 g. After the monomer mixture dosing was finished, the reaction mixture was pressure transferred into external mixing equipment, for reaction with 40 g of ethylene oxide (2.9 molar equivalent to lithium). After reaction with ethylene oxide, the reaction mixture was hydrolyzed using 25 mL of distilled water. The Polymer 2 solution, obtained after hydrolysis, was transferred into a separate vessel for water washing to remove the initiator residues. Washing was carried out by mixing the Polymer 2 solution with 200 mL of water and removing the water layer after phase separation. This washing step was repeated until the water layer became neutral (pH=7). Isolation of the product was done by the same procedure as in the above polymer preparation (Polymer 1). This Polymer 2, i.e. a comparative hydroxyl terminated styrene-butadiene random copolymer is referred to as SB-Fn0 in later sections. Another sample of this —OH terminated polymer was then reacted with 3-(triethoxysilyl)propyl isocyanate to produce a random silane terminated styrene-butadiene copolymer according to the invention. In later sections this random silane terminated styrene-butadiene copolymer sample is referred to as SB-Fn2.

Also prepared as comparative examples were two styrene-butadiene copolymers without the terminal silane functionality, as well as a homopolymer polybutadiene without the terminal silane functionality and a homopolymer polybutadiene with the terminal silane functionality. The properties of all of these polymers are set out in Table 1 below.

TABLE 1
Example 1 Polymers

| | | Product | Silane | | | | |
|---|---|---|---|---|---|---|---|
| | | name in | Functionality | | Vinyl | styrene | Tg, |
| Example | Copolymer type | charts | per chain | Mn | (%) | (%) | ° C. |
| Comparative | Random | SB-Fn0 | 0 | 2300 | 60 | 32 | −26 |
| | styrene/butadiene | | | | | | |
| | copolymer | | | | | | |
| Invention | Random | SB-Fn2 | 1.95 | 2300 | 60 | 32 | −25 |
| | styrene/butadiene | | | | | | |
| | copolymer | | | | | | |
| Invention | Block | SBS-Fn2 | 1.95 | 2500 | 65 | 27 | −30 |
| | styrene/butadiene/ | | | | | | |
| | styrene copolymer | | | | | | |
| Comparative | Random SB | Ricon100 | 0 | 4500 | 70 | 30 | −15 |
| Comparative | Homopolymer | Ricon603 | 1.95 | 3000 | 65 | 0 | −40 |
| | Polybutadiene | | | | | | |
| Comparative | Homopolymer | Ricon150 | 0 | 3900 | 70 | 0 | −40 |
| | polybutadiene | | | | | | |

### Example 2: Preparation of Cured Samples

A series of conventional summer tread tire compositions were prepared. As shown in Table 2, the tire compositions were all the same except that each composition included 20 parts per hundred rubber (ppr) of the Example 1 polymers shown in Table 1. The tire composition is set forth in Table 2.

TABLE 2
Curable compositions using polymers of Example 1

| Ingredient | Amount (phr) |
|---|---|
| High Cis Butadiene Rubber (Buna CB40) | 25 |
| SSBR (Buna VSL 5025-2HM) | 75 |
| Silica (Z1165MP) | 68 |
| Silane coupling agent - 50% on CB | 6.8 |
| Example 1 Polymer | 20 |
| Sulfur/TBBS/stearic acid/ZnO (vulcanizing agent) | 2.3/2.3/2.3/2.3 |

### Example 3: Glass Transition Temperature Measurement

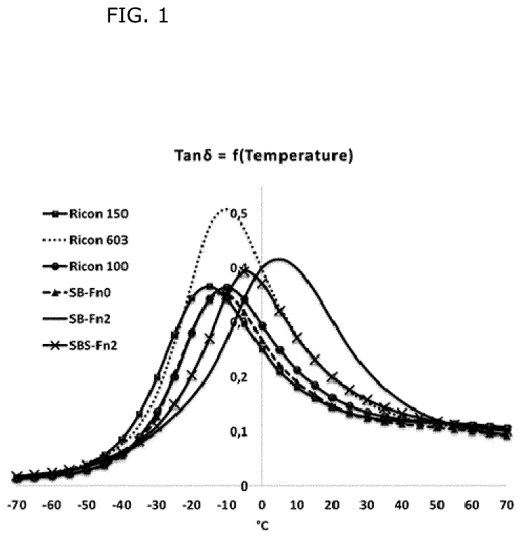

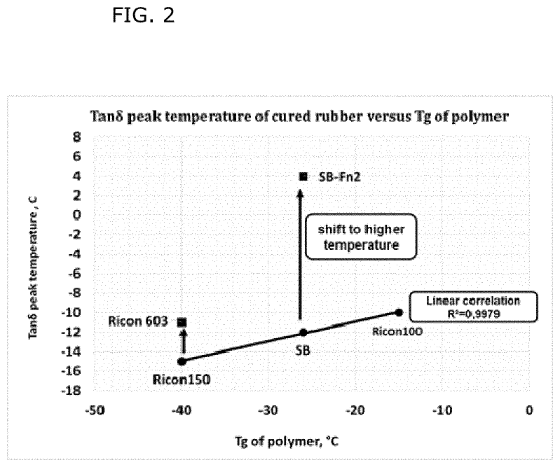

The first part of the study concerns the impact of the different polymers on the Tg of the cured compositions of Example 2. The 2 mm rubber sheets were cured at 160° C. under pressure to be evaluated with DMA equipment to provide the cured tan δ in order to determine the peak temperature (i.e., the Tg of the cured composition). FIG. 1 and FIG. 2 show that the compositions according to the invention modified with terminal triethoxy silane (SB-Fn2 and SBS) functionalities shifted the Tg of the cured compositions more strongly to a higher temperature compared to comparative composition that includes the terminal triethoxy silane (Ricon 603 in FIG. 2). In FIG. 2, this is demonstrated by the larger shift upward for the inventive composition from the lower line representing the Tg's of the analogous comparative example Ricon 603, which includes the terminal silane groups, but whose backbone chain is not according to the invention.

### Example 4: Tire Performance

The cured compositions were tested with dynamic mechanical analysis (DMA) and a rebound test. These two tests are related to certain tire properties as shown in Table 3 below. In particular, DMA performed at 10 Hz and 0.1% deformation at 0° C., 25° C. and 60° C. can provide indications of the relative expected wet adherence, dry traction, and rolling resistance, respectively. In addition, DMA was used to measure the peak tan δ temperature (i.e., the Tg). The testing results are shown in Table 3.

TABLE 3
Example 4 results

| Test | | Ricon150 | Ricon603 | SB-Fn0 | SB-Fn2 | SBS-Fn2 |
|---|---|---|---|---|---|---|
| (+/−standard deviation) | | Comp. | Comp. | Comp. | Inv. | Inv. |
| DMA | wet adherence | 0.268 | 0.397 | 0.27 | 0.402 | 0.374 |
| analysis | (higher is better) | | | | | |
| 10 Hz at | Tan δ 0° C. | | | | | |
| 0.1% | (+/−0.005) | | | | | |
| deformation | Dry traction | 0.101 | 0.175 | 0.135 | 0.253 | 0.178 |
| | (higher is better) | | | | | |
| | Tan δ 25° C. | | | | | |
| | (+/−0.005) | | | | | |
| | Rolling resistance | −12 | 0.107 | 0.105 | 0.104 | 0.109 |
| | Lower is better | | | | | |
| | Tan δ 60° C. | | | | | |
| | (+/−0.005) | | | | | |
| | Peak Tan δ | −16.5 | −11 | −12 | 4 | −4 |
| | Temperature, ° C. | | | | | |
| Rebound | wet adherence | 50 | 42 | 35 | 33 | 38 |
| test % | (lower is better) | | | | | |
| | Rebound 23° C. | | | | | |
| | (+/−0.7) | | | | | |
| | Rolling resistance | 0.268 | 61 | 50 | 63 | 63 |
| | (higher is better) | | | | | |
| | Rebound 70° C. | | | | | |
| | (+/−0.7) | | | | | |

Based on the results of Example 4 shown in Table 3, the silane terminated copolymer structures according to the invention provided the best tire properties. The random copolymer having terminal silane groups (SB-Fn2), provided a somewhat better balance of tire properties than the block copolymer having terminal silane groups (SS-Fn2), and the silane-terminated copolymers of the invention (SN-Fn2 and SBS-Fn2) both provided a better balance of properties than a non-silane terminated copolymer (SB-Fn0) or a silane terminated homopolymer (Ricon603) or a non-silane terminated homopolymer (Ricon150) as shown in Table 3.

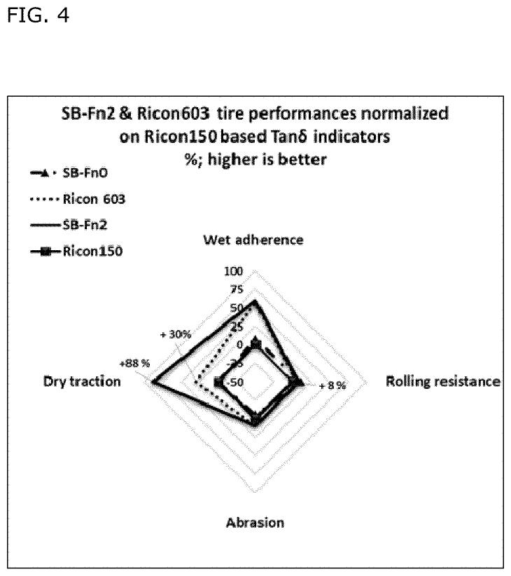

Payne Effect testing was also performed to determine the effect of intramolecular deformation-induced changes in the materials' microstructures for the inventive and comparative cured samples. FIG. 4 shows these results on samples that were cured to a Shore A hardness of 62.

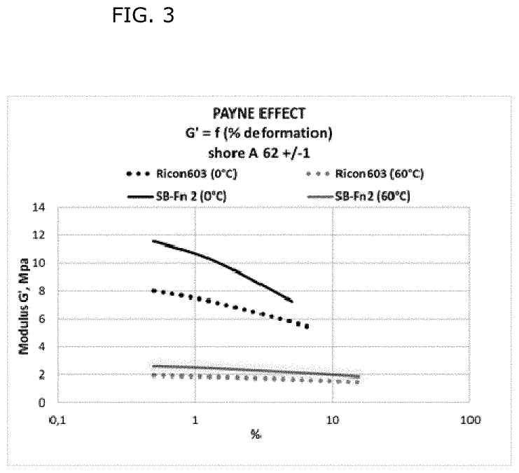

The combination of tan δ shift to higher temperature and intramolecular interaction inside the cured tire tread compound for the copolymers having the silane functional termination leads to this specific hysteresis which is characterized by a high Tan δ at 25 and 0° C. and low Tan δ at 60° C. Notably, these results are not what is observed usually where an increase in Tan δ at 250° C. would be expected to lead to a low Tan δ at 60° C. While not wanting to be bound be theory, this behavior may be the effect of molecular interactions inside the cured rubber at low temperature that do not exist at higher temperature as demonstrated by the Payne effect analysis shown in FIG. 3. Both rubbers including the non-functionalized styrene butadiene copolymer and butadiene homopolymer have similar G′ moduli. The modulus of the material including the non-silane material is lower at 0° C. than the material including the silanized material which may demonstrate that no molar interactions are occurring when the silane terminated copolymers are not grafted on silica. Without wishing to be bound by theory, it may be that the non-silane material is in an elastomer phase while the silanized material is bound to the silica. At 60° C., all interactions are broken, leading to similar G′ modulus for all materials.

Again without being bound to a theory, the combination of Tan δ shift to high temperature and intramolecular interaction inside tire tread compound including the silane-terminated copolymers of butadiene and styrene may lead to this specific hysteresis characterized by a high tan δ at 25° and 0° C. and low tan δ at 60° C. These results are not what is typically observed. This behavior may be the result of molecular interactions inside the cured rubber composition at low temperature that does not exist at higher temperatures as demonstrated by the Payne effect analysis as shown in FIG. 3.

Conclusion: Compared to the other silane terminated copolymers, the SB-Fn2 and the SBS-Fn2 (i.e. silane terminated random and block copolymers of styrene and butadiene) has a unique effect on the cured silica filled tire composition as characterized by a strong shift to high of Tg, although the composition retain a desirably relatively low Tg. In addition, SB-Fn2 or SBS-Fn2 may provide intermolecular interactions which exist at 25° C. but not at 60° C. The combination of these two effects in these terminal silane modified polymers based on random or block copolymers of styrene and butadiene have a strong impact on silica tire tread compositions leading to a high performance for wet adherence, dry traction and rolling resistance as shown in FIG. 4. This result is not seen in the comparative examples.

What is claimed is:

1. A curable rubber composition comprising:
a high molecular weight diene elastomer;
a silica composition;
an optional carbon black composition; and
a silane terminated copolymer different from the high molecular weight diene elastomer comprising, as polymerized units, monomers comprising conjugated dienes and vinyl aromatics, the silane terminated copolymer having at least one terminal end modified with at least one silane group.

2. The curable rubber composition of claim 1, wherein the silane terminated copolymer is a random copolymer.

3. The curable rubber composition of claim 1, wherein the number average molecular weight of the silane terminated copolymer is 1000 g/mol to 40,000 g/mol.

4. The curable rubber composition of claim 1, wherein the silane terminated copolymer comprises at least 5 wt % of the vinyl aromatics monomer.

5. The curable rubber composition of claim 1 wherein the vinyl aromatics monomer comprises styrene.

6. The curable rubber composition of claim 1 wherein the conjugated diene comprises butadiene.

7. The curable rubber composition of claim 1, wherein the silane terminated copolymer comprises a vinyl content of 50% by weight or more.

8. The curable rubber composition of claim 1, wherein the silane group of the silane terminal polymer is represented by the following formula: —Si(OR)₃, where each R is independently a C1-C6 alkyl group or an aryl group, or an H.

9. The curable rubber composition of claim 1, wherein the silane group of the silane terminal polymer is represented by the following formula: —Si(OR)₃, where each R is an ethyl group.

10. The curable rubber composition of claim 1, wherein the silane terminated copolymer has a silane functionality of 2 or less.

11. The curable rubber composition of claim 1, wherein the silane terminated copolymer has a silane functionality of from 0.8 to 2.

12. The curable rubber composition of claim 1, wherein the high molecular weight diene elastomer has a number average molecular weight of above 75,000 g/mol.

13. A tire comprising a cured rubber composition comprised of:
a high molecular weight diene elastomer;
a silica composition;
an optional carbon black composition; and
a silane terminated copolymer different from the high molecular weight diene elastomer comprising, as polymerized units, monomers comprising conjugated dienes and vinyl aromatics, the silane terminated copolymer having at least one terminal end modified with at least one silane group.

14. The tire of claim 13, wherein the silane terminated copolymer is a random copolymer.

15. The tire of claim 13, wherein the number average molecular weight of the silane terminated copolymer is 1000 g/mol to 40,000 g/mol.

16. The tire of claim 13, wherein the silane terminated copolymer has a silane functionality of 2 or less.

17. The tire of claim 13, wherein the silane terminated copolymer has a silane functionality of from 0.8 to 2.

18. The tire of claim 13, wherein the silane terminated copolymer comprises at least 5 wt % of the vinyl aromatics monomer.

19. The tire of claim 13, wherein the vinyl aromatics monomer comprises styrene.

20. The tire of claim 13, wherein the conjugated diene comprises butadiene.

21. The tire of claim 13, wherein the vinyl content of the silane terminated copolymer is 50 wt % or more.

22. The tire of claim 13, wherein the silane group of the silane terminal polymer is represented by the following formula: —Si(OR)₃, where each R is independently a C1-C6 alkyl group or an aryl group, or an H.

23. The tire of claim 13, wherein the silane group of the silane terminal polymer is represented by the following formula: —Si(OR)₃, where each R is an ethyl group.

24. The tire of claim 13, wherein the curable rubber composition has been cured using at least one sulfur vulcanizing agent.

25. A method for producing a rubber composition adapted for use in a tire, the method comprising:
forming a composition by mixing a silica composition, a high molecular weight diene elastomer, optionally a carbon black composition, a silane terminated copolymer different from the high molecular weight diene elastomer comprising, as polymerized units, monomers comprising conjugated dienes and vinyl aromatics, the silane terminated copolymer having at least one terminal end modified with at least one silane group; and
curing the composition.
